(19) United States
(12) Patent Application Publication
(10) Pub. No.: US 2022/0126824 A1
(43) Pub. Date: Apr. 28, 2022

(54) VEHICLE CONTROL DEVICE, VEHICLE CONTROL METHOD, AND STORAGE MEDIUM

(71) Applicant: HONDA MOTOR CO., LTD., Tokyo (JP)

(72) Inventor: Daichi Kato, Wako-shi (JP)

(21) Appl. No.: 17/504,551

(22) Filed: Oct. 19, 2021

(30) Foreign Application Priority Data
Oct. 23, 2020 (JP) 2020-178099

(51) Int. Cl. B60W 30/12

(52) U.S. Cl. CPC B60W 30/12; B60W 2552/30

(57) ABSTRACT

A vehicle control device includes: a first line generator configured to generate a first line based on a shape of a road in a travel direction of a vehicle; a second line generator configured to generate a second line such that the second line is closer to the first line than in an initial state at a target arrival point by using the initial state including at least a lateral difference between the vehicle and the first line and a target state including at least the target arrival point as parameters of a geometric curve; a third line generator configured to generate a third line based on a target value for causing a lateral difference between the first line and the second line to approach zero by feedback control; and a travel controller configured to cause the vehicle to travel based on the third line.

### CROSS-REFERENCE TO RELATED APPLICATION

Priority is claimed on Japanese Patent Application No. 2020-178099, filed Oct. 23, 2020, the content of which is incorporated herein by reference.

### BACKGROUND

### Field of the Invention

The present invention relates to a vehicle control device, a vehicle control method, and a storage medium.

### Description of Related Art

In the related art, techniques of generating a trajectory of a vehicle have been disclosed (Japanese Unexamined Patent Application, First Publication No. 2015-110403).

### SUMMARY

In the related art, a process of generating a trajectory may not be performed in appropriate sub stages and thus accuracy is not satisfactory or a processing load may be excessively large.

The invention has been made in consideration of the aforementioned circumstances and an objective thereof is to provide a vehicle control device, a vehicle control method, and a storage medium that can realize improvement in accuracy and curbing a processing load.

A vehicle control device, a vehicle control method, and a storage medium according to the invention employ the following configurations:

(1) A vehicle control device according to an aspect of the invention includes a storage device that stores a program and a hardware processor. By executing the program stored in the storage device, the hardware processor is configured to generate a first line based on a shape of a road in a travel direction of a vehicle, to generate a second line such that the second line is closer to the first line than in an initial state at a target arrival point by using the initial state including at least a lateral difference between the vehicle and the first line and a target state including at least the target arrival point as parameters of a geometric curve, to generate a third line based on a target value for causing a lateral difference between the first line and the second line to approach zero by feedback control, and to cause the vehicle to travel based on the third line.

(2) In the aspect of (1), the hardware processor may be configured to repeatedly perform generating the first line, generating the second line, and generating the third line at intervals of a control cycle, and to set a lateral difference between a point corresponding to a position of the vehicle in a current control cycle on the second line generated in previous control cycle and the first line in the current control cycle as the lateral difference between the vehicle and the first line which is included in the initial state.

(3) In the aspect of (2), the initial state may further include an initial movement direction, and the hardware processor may be configured to set a direction of a tangent to the point corresponding to the position of the vehicle in the current control cycle to the second line generated in the previous control cycle as the initial movement direction.

(4) In the aspect of (2) or (3), the hardware processor may be configured to calculate a lateral position of the target arrival point in consideration of limitation based on a change from the initial state and limitation based on a change from the previous control cycle.

(5) In the aspect of (4), the hardware processor may be configured to select the larger of a lateral movement amount obtained by limiting the change from the previous control cycle using a rate limiter and a load sum of a lateral movement amount calculated in the previous control cycle and a lateral movement amount calculated in the current control cycle, to select the smaller of the selected lateral movement amount and a lateral movement amount calculated according to the limitation based on the change from the initial state, and to calculate the lateral position of the target arrival point based on the lateral movement amount selected as the smaller.

(6) A vehicle control method according to another aspect of the invention is performed by a vehicle control device, and the vehicle control method includes: generating a first line based on a shape of a road in a travel direction of a vehicle; generating a second line such that the second line is closer to the first line than in an initial state at a target arrival point by using the initial state including at least a lateral difference between the vehicle and the first line and a target state including at least the target arrival point as parameters of a geometric curve; generating a third line based on a target value for causing a lateral difference between the first line and the second line to approach zero by feedback control; and causing the vehicle to travel based on the third line.

(7) A non-transitory computer-readable storage medium according to another aspect of the invention stores a program causing a processor of a vehicle control device to perform: generating a first line based on a shape of a road in a travel direction of a vehicle; generating a second line such that the second line is closer to the first line than in an initial state at a target arrival point by using the initial state including at least a lateral difference between the vehicle and the first line and a target state including at least the target arrival point as parameters of a geometric curve; generating a third line based on a target value for causing a lateral difference between the first line and the second line to approach zero by feedback control; and causing the vehicle to travel based on the third line.

According to the aspects of (1) to (7), it is possible to realize improvement in accuracy and curbing a processing load.

### BRIEF DESCRIPTION OF THE DRAWINGS

FIG. 1 is a diagram illustrating a configuration of a vehicle system using a vehicle control device according to an embodiment.

FIG. 2 is a diagram illustrating functional configurations of a first controller and a second controller.

FIG. 3 is a diagram schematically illustrating a process of generating a target trajectory.

FIG. 4 is a diagram illustrating a process which is performed by a successive trajectory generator.

FIG. 5 is a diagram illustrating an example of a functional configuration of a reference line generator.

FIG. 6 is a diagram illustrating an example of a functional configuration of an initial state calculator.

FIG. 7 is a diagram illustrating an example of a functional configuration for calculating a target-state longitudinal position in a target state calculator.

FIG. 8 is a diagram illustrating an example of a method of setting a target convergence time which is performed by a target convergence time setter.

FIG. 9 is a diagram illustrating an example of a functional configuration for calculating a target-state lateral position in the target state calculator.

FIG. 10 is a diagram illustrating an example of characteristics of a target-state transition ratio.

FIG. 11 is a diagram illustrating a process that is performed by the target state calculator.

FIG. 12 is a diagram illustrating a situation in which an extraction range of a turning radius R is determined.

FIG. 13 is a diagram illustrating a situation in which a temporary target state correction value corresponding to a turning radius R is determined.

FIG. 14 is a diagram illustrating a process that is performed by a difference convergence reference calculator.

FIG. 15 is a diagram illustrating a situation in which a lateral difference convergence coefficient is set.

FIG. 16 is a diagram illustrating process details that are performed by a time-series tracking trajectory generator.

FIG. 17 is a diagram illustrating a process that is performed by an output route generator.

FIG. 18 is a diagram illustrating an extrapolation process.

FIG. 19 is a diagram illustrating a method of determining a coefficient.

FIG. 20 is a diagram illustrating a process of generating additional information.

FIG. 21 is a diagram illustrating an example of characteristics for determining a calculation range of a boundary line of a travel lane which is recognized by a camera.

### DESCRIPTION OF EMBODIMENTS

Hereinafter, a vehicle control device, a vehicle control method, and a storage medium according to an embodiment of the invention will be described below with reference to the accompanying drawings.

Overall Configuration

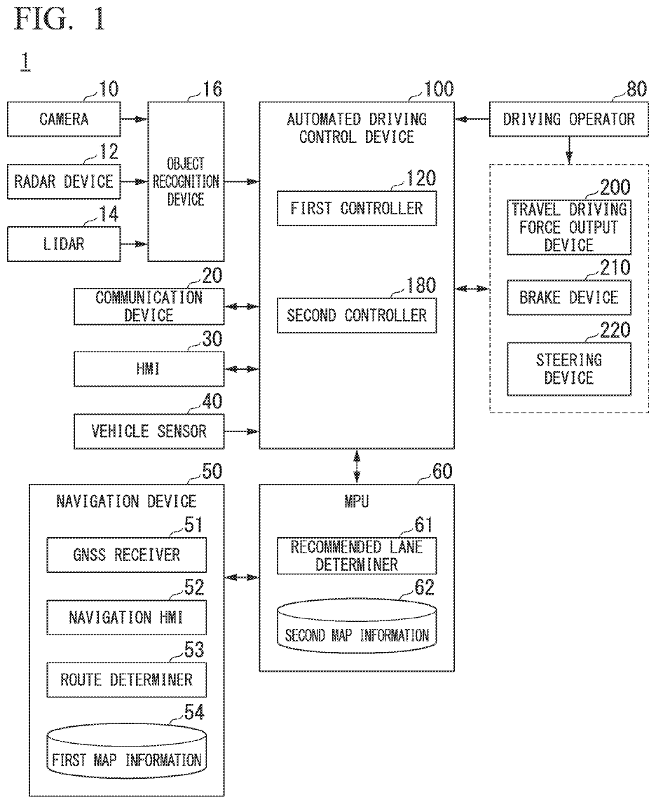

FIG. 1 is a diagram illustrating a configuration of a vehicle system 1 employing a vehicle control device according to an embodiment. A vehicle in which the vehicle system 1 is mounted may be, for example, a vehicle with two wheels, three wheels, or four wheels and a drive source thereof may be an internal combustion engine such as a diesel engine or a gasoline engine, an electric motor, or a combination thereof. The electric motor operates using electric power which is generated by a power generator connected to the internal combustion engine or electric power which is discharged from a secondary battery or a fuel cell.

The vehicle system 1 includes, for example, a camera 10, a radar device 12, a Light Detection and Ranging (LiDAR) device 14, an object recognition device 16, a communication device 20, a human-machine interface (HMI) 30, a vehicle sensor 40, a navigation device 50, a map positioning unit (MPU) 60, a driving operator 80, an automated driving control device 100, a travel driving force output device 200, a brake device 210, and a steering device 220. These devices or instruments are connected to each other via a multiplex communication line such as a controller area network (CAN) communication line, a serial communication line, a radio communication network, or the like. The configuration illustrated in FIG. 1 is only an example and a part of the configuration may be omitted or another configuration may be added thereto.

The camera 10 is, for example, a digital camera using a solid-state imaging device such as a charge coupled device (CCD) or a complementary metal oxide semiconductor (CMOS). The camera 10 is attached to an arbitrary position on a vehicle in which the vehicle system 1 is mounted (hereinafter, referred to as a host vehicle M). When the front view of the vehicle is imaged, the camera 10 is attached to an upper part of a front windshield, a rear surface of a rearview mirror, or the like. The camera 10 images surroundings of the host vehicle M, for example, periodically and repeatedly. The camera 10 may be a stereoscopic camera.

The radar device 12 radiates radio waves such as millimeter waves to the surroundings of the host vehicle M, detects radio waves (reflected waves) reflected by an object, and detects at least a position (a distance and a direction) of the object. The radar device 12 is attached to an arbitrary position on the host vehicle M. The radar device 12 may detect a position and a speed of an object using a frequency modulated continuous wave (FM-CW) method.

The LiDAR device 14 emits light (or electromagnetic waves of wavelengths close to those of the light) to the surroundings of the host vehicle M and measures scattered light. The LiDAR device 14 detects a distance to an object based on a time from emission of light to reception of light. The emitted light is, for example, a pulse-like laser beam. The LiDAR device 14 is attached to an arbitrary position on the host vehicle M.

The object recognition device 16 performs a sensor fusion process on results of detection from some or all of the camera 10, the radar device 12, and the LiDAR device 14 and recognizes a position, a type, a speed, and the like of an object. The object recognition device 16 outputs the result of recognition to the automated driving control device 100. The object recognition device 16 may output the results of detection from the camera 10, the radar device 12, and the LiDAR device 14 to the automated driving control device 100 without any change. The object recognition device 16 may be omitted from the vehicle system 1.

The communication device 20 communicates with other vehicles near the host vehicle M, for example, using a cellular network, a Wi-Fi network, Bluetooth (registered trademark), or dedicated short range communication (DSRC) or communicates with various server devices via a radio base station.

The HMI 30 presents various types of information to an occupant of the host vehicle M and receives an input operation from the occupant. The HMI 30 includes various display devices, speakers, buzzers, a touch panel, switches, and keys.

The vehicle sensor 40 includes a vehicle speed sensor that detects a speed of the host vehicle M, an acceleration sensor that detects an acceleration, a yaw rate sensor that detects an angular velocity around a vertical axis, and a direction sensor that detects a direction of the host vehicle M.

The navigation device 50 includes, for example, a global navigation satellite system (GNSS) receiver 51, a navigation HMI 52, and a route determiner 53. The navigation device 50 stores first map information 54 in a storage device such as a hard disk drive (HDD) or a flash memory. The GNSS receiver 51 identifies the position of the host vehicle M based on signals received from GNSS satellites. The position of the host vehicle M may be identified or corrected by an inertial navigation system (INS) using the output of the vehicle sensor 40. The navigation HMI 52 includes a display device, a speaker, a touch panel, and keys. All or some elements of the navigation HMI 52 may be shared by the HMI 30. For example, the route determiner 53 determines a route (hereinafter referred to as a route on a map) from the position of the host vehicle M identified by the GNSS receiver 51 (or an input arbitrary position) to a destination input by an occupant using the navigation HMI 52 with reference to the first map information 54. The first map information 54 is, for example, information in which road shapes are expressed by links indicating roads and nodes connected by the links. The first map information 54 may include curvatures of roads or point of interest (POI) information. The route on a map is output to the MPU 60. The navigation device 50 may perform guidance for a route using the navigation HMI 52 based on the route on a map. The navigation device 50 may be realized, for example, by a function of a terminal device such as a smartphone or a tablet terminal which is carried by an occupant. The navigation device 50 may transmit a current position and a destination to a navigation server via the communication device 20 and acquire a route which is equivalent to the route on a map from the navigation server.

The MPU 60 includes, for example, a recommended lane determiner 61 and stores second map information 62 in a storage device such as an HDD or a flash memory. The recommended lane determiner 61 divides a route on a map supplied from the navigation device 50 into a plurality of blocks (for example, blocks at every 100 [m] in a vehicle travel direction) and determines a recommended lane for each block with reference to the second map information 62. The recommended lane determiner 61 determines in which lane from the leftmost the host vehicle M is to travel. When there is a branching point in the route on a map, the recommended lane determiner 61 determines a recommended lane such that the host vehicle M travels on a rational route for movement to a branching destination.

The second map information 62 is map information with higher precision than the first map information 54. The second map information 62 includes, for example, information on the centers of lanes or information on boundaries of lanes. The second map information 62 may include road information, traffic regulation information, address information (addresses and postal codes), facility information, and phone number information. The second map information 62 may be updated from time to time by causing the communication device 20 to communicate with another device.

The driving operator 80 includes, for example, an accelerator pedal, a brake pedal, a shift lever, a steering wheel, a deformed steering wheel, a joystick, and other operators. A sensor that detects an amount of operation or whether an operation has been performed is attached to the driving operator 80, and a result of detection thereof is output to some or all of the automated driving control device 100, the travel driving force output device 200, the brake device 210, and the steering device 220.

The automated driving control device 100 includes, for example, a first controller 120 and a second controller 180. The first controller 120 and the second controller 180 are realized, for example, by causing a hardware processor such as a central processing unit (CPU) to execute a program (software). Some or all of such elements may be realized in hardware (which includes circuitry) such as a large scale integration (LSI), an application-specific integrated circuit (ASIC), or a field-programmable gate array (FPGA), or a graphics processing unit (GPU) or may be realized in cooperation of software and hardware. The program may be stored in a storage device (a storage device including a non-transitory storage medium) such as an HDD or a flash memory of the automated driving control device 100 in advance, or may be installed in the HDD or the flash memory of the automated driving control device 100 by storing the program in a removable storage medium such as a DVD or a CD-ROM and putting the removable storage medium (a non-transitory storage medium) to a drive device. The automated driving control device 100 is an example of a “vehicle control device” and the second controller 180 is an example of a “travel controller.”

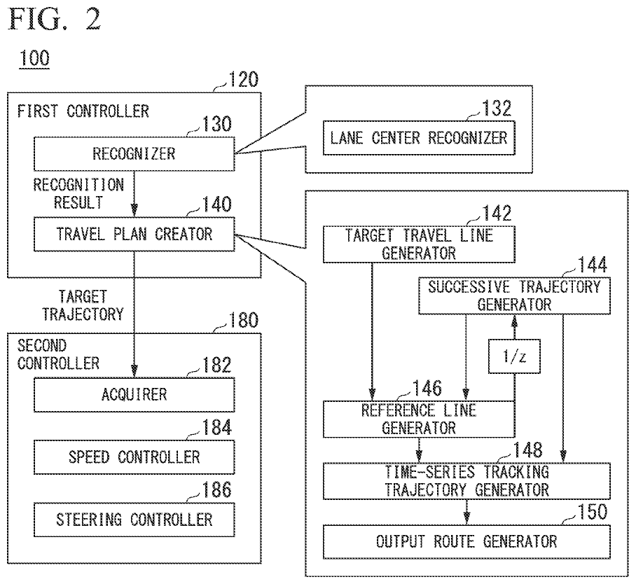

FIG. 2 is a diagram illustrating functional configurations of the first controller 120 and the second controller 180. The first controller 120 includes, for example, a recognizer 130 and a movement plan creator 140. The first controller 120 realizes, for example, a function based on an artificial intelligence (AI) and a function based on a predetermined model together. For example, a function of “recognizing a crossing” may be embodied by performing recognition of a crossing based on deep learning or the like and recognition based on predetermined conditions (such as signals and road signs which can be pattern-matched) together, scoring both recognitions, and comprehensively evaluating both recognitions. Accordingly, reliability of automated driving is secured.

The recognizer 130 recognizes states such as a position, a speed, and an acceleration of an object near the host vehicle M based on information which is input from the camera 10, the radar device 12, and the LiDAR device 14 via the object recognition device 16. For example, a position of an object is recognized as a position in an absolute coordinate system with an origin set to a representative point of the host vehicle M (such as the center of gravity or the center of a drive shaft) and is used for control. A position of an object may be expressed as a representative point such as the center of gravity or a corner of the object or may be expressed as a drawn area. A “state” of an object may include an acceleration or a jerk of the object or a “moving state” (for example, whether lane change is being performed or whether lane change is going to be performed) thereof.

The recognizer 130 recognizes, for example, a lane (a travel lane) in which the host vehicle M is traveling. For example, the recognizer 130 recognizes the travel lane by comparing a pattern of road markings near the host vehicle M which are recognized from an image captured by the camera 10 with a pattern of road markings (for example, arrangement of a solid line and a dotted line) which are acquired from the second map information 62. The recognizer 130 is not limited to the road markings, but may recognize the travel lane by recognizing travel road boundaries (road boundaries) including road markings, edges of roadsides, curbstones, medians, and guard rails. The recognizer 130 includes a lane center recognizer 132. The lane center recognizer recognizes a straight line or a curve connecting center points in the width direction of the travel lane (hereinafter referred to as a lane center). In this recognition, the position of the host vehicle M acquired from the navigation device 50 and the result of processing from the INS may be considered. The recognizer 130 recognizes a stop line, an obstacle, a red signal, a toll gate, or other road events.

The recognizer 130 recognizes a position or a direction of the host vehicle M with respect to a travel lane at the time of recognition of the travel lane. The recognizer 130 may recognize, for example, a separation of a reference point of the host vehicle M from the lane center and an angle of the travel direction of the host vehicle M with respect to a line formed by connecting the lane centers as the position and the direction of the host vehicle M relative to the travel lane. Instead, the recognizer 130 may recognize a position of the reference point of the host vehicle M relative to one side line of the travel lane (a road marking or a road boundary) or the like as the position of the host vehicle M relative to the travel lane.

The movement plan creator 140 creates a target trajectory in which the host vehicle M will travel autonomously (without requiring a driver's operation) in the future such that the host vehicle M travels in the recommended lane determined by the recommended lane determiner 61 in principle and copes with surrounding circumstances of the host vehicle M. A target trajectory includes, for example, a speed element. For example, a target trajectory is expressed by sequentially arranging points (trajectory points) at which the host vehicle M is to arrive. Trajectory points are points at which the host vehicle M is to arrive at intervals of a predetermined travel distance (for example, every about several [m]) along a road, and a target speed and a target acceleration at intervals of a predetermined sampling time (for example, about below the decimal point [sec]) are generated as a part of a target trajectory in addition thereto. Trajectory points may be positions at which the host vehicle M is to arrive at sampling timing every predetermined sampling time. In this case, information of the target speed or the target acceleration is expressed by intervals between the trajectory points.

The movement plan creator 140 may set events of automated driving in creating a target trajectory. The events of automated driving include a constant-speed travel event, a low-speed following travel event, a lane change event, a branching event, a merging event, and a take-over event. The movement plan creator 140 creates a target trajectory based on events which are started.

The movement plan creator 140 includes, for example, a target travel line generator 142, a successive trajectory generator 144, a reference line generator 146, a time-series tracking trajectory generator 148, an output route generator 150, and a level determiner 152. Detailed processes of these functional units will be described later.

The second controller 180 controls the travel driving force output device 200, the brake device 210, and the steering device 220 such that the host vehicle M travels along the target trajectory created by the movement plan creator 140 as scheduled.

Referring back to FIG. 2, the second controller 180 includes, for example, an acquirer 162, a speed controller 164, and a steering controller 166. The acquirer 162 acquires information of a target trajectory (trajectory points) created by the movement plan creator 140 and stores the acquired information in a memory (not illustrated). The speed controller 164 controls the travel driving force output device 200 or the brake device 210 based on a speed element accessory to the target trajectory stored in the memory. The steering controller 166 controls the steering device 220 based on a curved state of the target trajectory stored in the memory. The processes of the speed controller 164 and the steering controller 166 are realized, for example, in combination of feed-forward control and feedback control. For example, the steering controller 166 performs control in combination of feed-forward control based on a curvature of a road in front of the host vehicle M and feedback control based on a separation from the target trajectory.

The travel driving force output device 200 outputs a travel driving force (a torque) for allowing a vehicle to travel to the driving wheels. The travel driving force output device 200 includes, for example, a combination of an internal combustion engine, an electric motor, and a transmission and an electronic control unit (ECU) that controls them. The ECU controls the aforementioned elements based on information input from the second controller 180 or information input from the driving operator 80.

The brake device 210 includes, for example, a brake caliper, a cylinder that transmits a hydraulic pressure to the brake caliper, an electric motor that generates a hydraulic pressure in the cylinder, and a brake ECU. The brake ECU controls the electric motor based on the information input from the second controller 180 or the information input from the driving operator 80 such that a brake torque based on a braking operation is output to vehicle wheels. The brake device 210 may include a mechanism for transmitting a hydraulic pressure generated by an operation of a brake pedal included in the driving operator 80 to the cylinder via a master cylinder as a backup. The brake device 210 is not limited to the above-mentioned configuration, and may be an electronically controlled hydraulic brake device that controls an actuator based on information input from the second controller 180 such that the hydraulic pressure of the master cylinder is transmitted to the cylinder.

The steering device 220 includes, for example, a steering ECU and an electric motor. The electric motor changes a direction of turning wheels, for example, by applying a force to a rack-and-pinion mechanism. The steering ECU drives the electric motor based on the information input from the second controller 180 or the information input from the driving operator 80 to change the direction of the turning wheels.

[Generation of Target Trajectory]

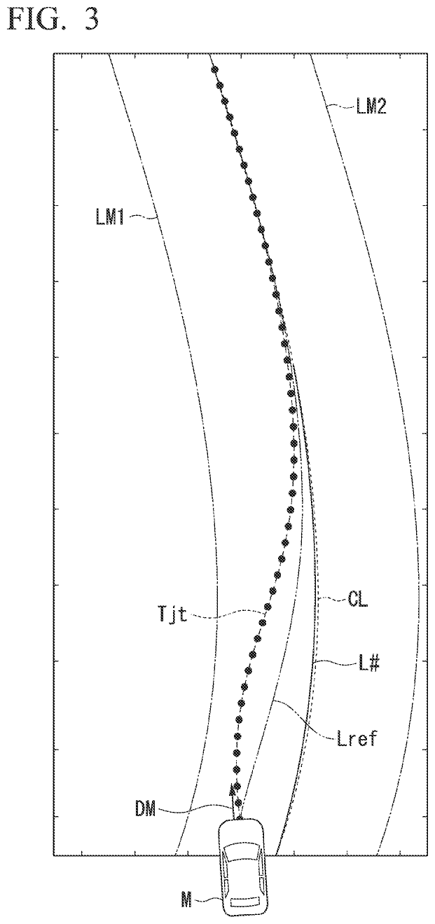

Processes of the constituents of the movement plan creator 140 for generating a target trajectory will be described below. The movement plan creator 140 performs stepwise generating of a target travel line, a reference line, and a time-series tracking trajectory based on the lane center recognized by the lane center recognizer 132 and finally outputting a target trajectory for each control cycle. In the following description, the control cycles which come repeatedly are referred to a current control cycle, a previous control cycle, and the like. FIG. 3 is a diagram schematically illustrating a process of generating a target trajectory. In the drawing, an arrow DM indicates a travel direction of the host vehicle M and a direction of a vehicle body axis. Reference sign LM1 indicates a left road marking, LM2 indicates a right road marking, CL indicates a lane center, L # indicates a target travel line, Lref indicates a reference line, and Tjt indicates a time-series tracking trajectory. In the drawing, the horizontal axis represents coordinates substantially in a road width direction relative to a representative point (which is set to the center of front part, the drive shaft center, the center of gravity, or the like) of the host vehicle M, and the vertical axis represents coordinates substantially in a road extension direction. In the following description, substantially the road width direction is referred to as a “lateral direction” and substantially the road extension direction is referred to as a “longitudinal direction.”

The target travel line generator 142 generates the target travel line L # by performing a desired process such as moving the target trajectory aside with respect to the lane center CL inward in a curve. The target travel line generator 142 generates the target travel line L # such that the target travel line is switched from the travel lane of the host vehicle M to a lane center of a lane which is a lane change destination at a desired point of the travel destination of the host vehicle M in a situation in which the host vehicle M is to perform lane change. The target travel line L # is an example of a “first line.”

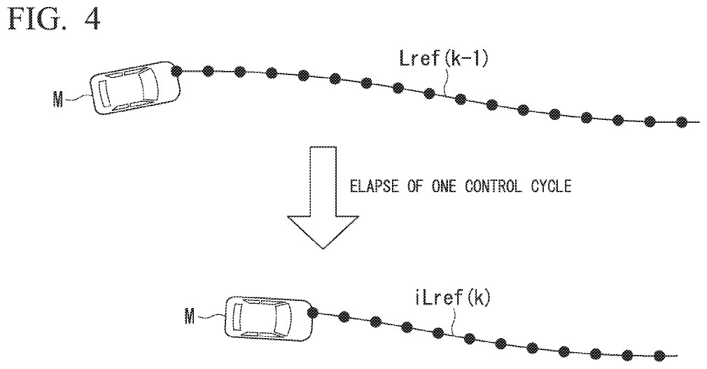

The successive trajectory generator 144 generates a line obtained by cutting the reference line Lref generated in the previous control cycle to correspond to a part in the travel direction from a position corresponding to the position of the representative point of the host vehicle M in the current control cycle (a position at which the reference line crosses a straight line extending in the lateral direction from the representative point of the host vehicle M) as a successive trajectory in consideration of traveling of the host vehicle M with the elapse of time corresponding to one control cycle. When the host vehicle M stops, the successive trajectory is the same as the reference line Lref. FIG. 4 is a diagram illustrating a process which is performed by the successive trajectory generator 144. In the drawing, iL indicate a successive trajectory and “k−1” and “k” in parentheses indicate the control cycles. Here, k is an arbitrary natural number.

[Generation of Reference Line]

The reference line generator 146 generates the reference line Lref based on an initial state acquired from the successive trajectory iLref and a target arrival point set with respect to the target travel line. The reference line generator 146 generates the reference line Lref using the initial state and the target arrival point as input parameters of a geometric curve such as a Bezier curve. The reference line Lref is an example of a “second line.” A structure for curbing sudden change when lane recognition is temporarily lacking or the like is included in the process performed by the reference line generator 146.

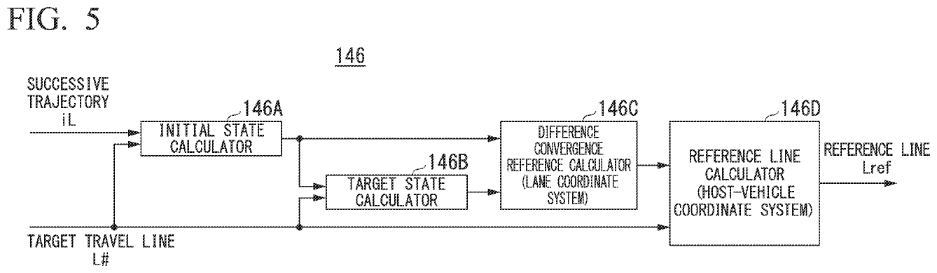

FIG. 5 is a diagram illustrating an example of the functional configuration of the reference line generator 146. The reference line generator 146 includes, for example, an initial state calculator 146A, a target state calculator 146B, a difference convergence reference calculator 146C, and a reference line calculator 146D. The reference line generator 146 generates the reference line Lref such that the reference line Lref at the target arrival point approaches (matches as much as possible) the target travel line L #.

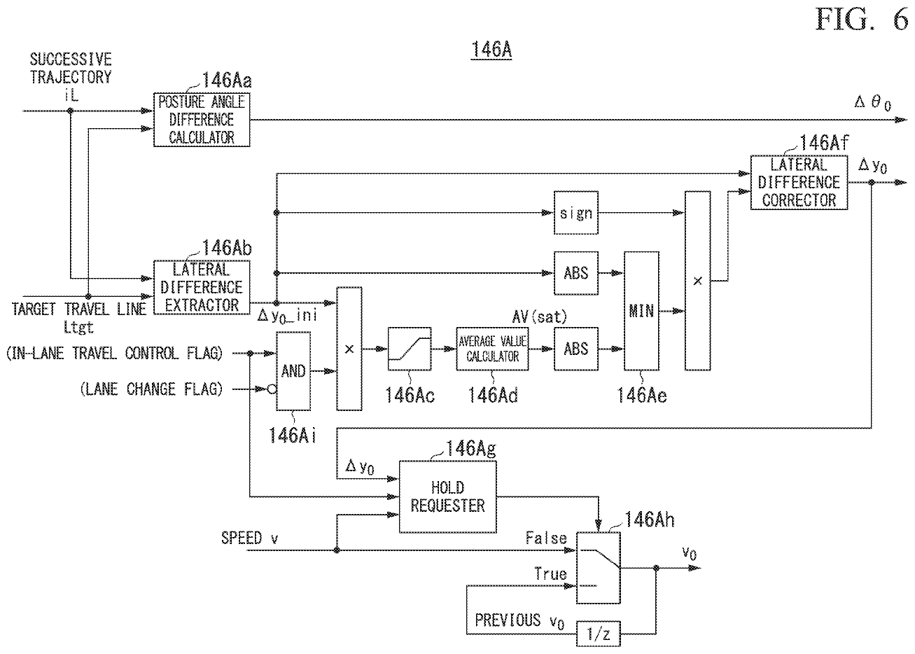

FIG. 6 is a diagram illustrating an example of the functional configuration of the initial state calculator 146A. The initial state calculator 146A includes, for example, a posture angle difference calculator 146Aa, a lateral difference extractor 146Ab, a saturation processor 146Ac, an average value calculator 146Ad, a minimum value output unit 146Ae, a lateral difference corrector 146Af, a hold requester 146Ag, and a selector 146Ah.

The posture angle difference calculator 146Aa calculates an angle formed by a tangent line to a start point of the successive trajectory iL and a tangent line to a start point of the target travel line as an initial-state posture angle difference Δθ₀.

The lateral difference extractor 146Ab calculates a distance in the road width direction between the start point of the successive trajectory iL and the start point of the target travel line as a temporary lateral difference Δy₀_ini.

When the temporary lateral difference Δy₀_ini is output as an initial-state lateral difference Δy₀ without any change, a phenomenon in which the reference line Lref steadily separates from the target travel line L # and does not converge on the target travel line L # may occur. Therefore, the initial state calculator 146A corrects the start point of the successive trajectory iLref through the following process such that the start point of the successive trajectory iLref does not steadily separates from the start point of the target travel line L #.

A sign function value sign(Δy₀_ini) and an absolute value ABS(Δy₀_ini) of the temporary lateral difference Δy₀_ini are calculated by the initial state calculator 146A. The sign function is a function that outputs 1 when an input value is positive, outputs zero when the input value is zero, and outputs −1 when the input value is negative. On the other hand, a value of a negative logic of an in-lane travel control flag that is set to 1 when in-lane travel control is performed in the host vehicle M and 0 otherwise and a lane change flag that is set to 1 when the host vehicle M is performing lane change and 0 otherwise are input to an AND gate 146Ai, and the initial state calculator 146A calculates an effective lateral difference by multiplying the output of the AND gate 146Ai by the temporary lateral difference Δy₀_ini. The in-lane travel control is for mainly controlling steering of the host vehicle M such that the host vehicle M travels along the lane center CL and does not depart from a lane using various techniques. The effective lateral difference is limited to a maximum lateral difference (for example, several tens of [m]) by the saturation processor 146Ac (hereinafter the limited value is defined as sat), and an absolute value ABS(AV(sat)) of an average value AV(sat) is calculated after the average value AV(sat) of about 10 [sec] in the past has been calculated by the average value calculator 146Ad. The minimum value output unit 146Ae selectively outputs the smaller of the absolute value ABS(Δy₀_ini) and the absolute value ABS(AV(sat)).

The comparator 164Ae outputs the smaller value of a correction value at which the lateral difference between the successive trajectory iL and the target travel line L # is zero and an average value of the effective lateral difference limited by a maximum correction value. When the effective lateral difference limited to the maximum correction value has a steady value, the average value of the effective lateral difference increases gradually and the output of the comparator 164Ae increases. Accordingly, the output of the comparator 164Ae acts in a direction in which a steady separation between the start point of the successive trajectory iLref and the start point of the target travel line L # is cancelled out. A value obtained by multiplying the output of the comparator 164Ae by the value of the negative logic sign(Δy₀_ini) is input as a lateral difference correction value to the lateral difference corrector 146Af. The lateral difference corrector 146Af calculates the initial-state lateral difference Δy₀ by adding the temporary lateral difference Δy₀_ini and the lateral difference correction value, and outputs the calculated value.

The initial-state lateral difference Δy₀, the in-lane travel control flag, and the speed v of the host vehicle M are input to the hold requester 146Ag. The hold requester 146Ag outputs a hold request to the selector 146Ah when all of following conditions 1 to 3 are satisfied.

(Condition 1) The in-lane travel flag is set to 1.

(Condition 2) The speed v(k) in the current control cycle is higher than the speed v(k−1) in the previous control cycle.

(Condition 3) The initial-state lateral difference Δy₀ is greater than a prescribed value (for example, 0.3 [m]).

The selector 146Ah outputs the speed v of the host vehicle M input in the current control cycle as an initial-state speed v₀ when the hold request is not input (False), and outputs the initial-state speed v₀ output in the previous control cycle as the initial-state speed v₀ in the current control cycle when the hold request is input (Ture).

[Calculation of Target State]

The target state calculator 146B calculates a target state which is information of an end point and which is applied to a difference convergence reference which will be described later.

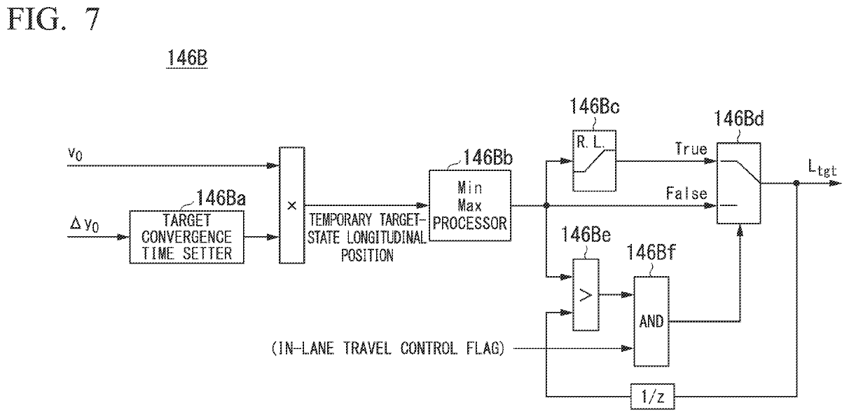

FIG. 7 is a diagram illustrating an example of a functional configuration for calculating a target-state longitudinal position Ltgt in the target state calculator 146B. The target state calculator 146B includes, for example, a target convergence time setter 146Ba, a MinMax processor 146Bb, a rate limiter 146Bc, a selector 146Bd, a comparator 146Be, and an AND gate 146Bf.

The initial-state lateral difference Δy₀ is input to the target convergence time setter 146Ba. The target convergence time setter 146Ba sets a target convergence time, for example, according to characteristics illustrated in FIG. 8 based on the initial-state lateral difference Δy₀. The target convergence time is a time indicating in what time the initial-state lateral difference Δy₀ is to be resolved.

FIG. 8 is a diagram illustrating an example of setting the target convergence time which is performed by the target convergence time setter 146Ba. In the drawing, (1) represents a setting rule in a normal state and (2) represents a setting rule at the time of cancellation of lane change. The “time of cancellation of lane change” is a time at which a flag is set up in a predetermined time after an execution trigger for lane change has occurred and is cancelled when a part of the host vehicle M enters a road marking. The target convergence time setter 146Ba sets the target convergence time to be substantially constant regardless of the initial-state lateral difference Δy₀ in the normal state, and sets the target convergence time such that the target convergence time increases with an increase of the initial-state lateral difference Δy₀ and is fixed to an upper limit when the target convergence time reaches the upper limit at the time of cancellation of lane change.

The target state calculator 146B calculates a temporary target-state longitudinal position by multiplying the initial-state speed v₀ by the target convergence time. The temporary target-state longitudinal position is input to the MinMax processor 146Bb. The MinMax processor 146Bb is configured to output a maximum value when the temporary target-state longitudinal position is greater than the maximum value and to output a minimum value when the temporary target-state longitudinal position is less than the minimum value. The maximum value is, for example, a value of about several hundreds [m], and the minimum value is, for example, a value of about several tens [m].

An output value obtained by inputting the output value of the MinMax processor 146Bb to the rate limiter 146Bc and the output value of the MinMax processor 146Bb are input to the selector 146Bd. The rate limiter 146Bc is configured to limit an increase in value between the previous control cycle and the current control cycle to a constant value. A rate limit value which is set by the rate limiter 146Bc is, for example, a value of about several [m/cnt]. Here, cnt means one control cycle.

The output value of the MinMax processor 146Bb is also input to the comparator 146Be. The comparator 146Be outputs 1 when the output value of the MinMax processor 146Bb is greater than a previous value of the target-state longitudinal position Ltgt. The AND gate 146Bf is configured to output 1 when both the output value of the comparator 146Be and the in-lane travel control flag are 1 and to output zero otherwise. The selector 146Bd is configured to output the output value of the rate limiter 146Bc as the target-state longitudinal position Ltgt when 1 is input from the AND gate 146Bf and to output the output value of the rate limiter 146Bc as the target-state longitudinal position Ltgt otherwise. That is, the target state calculator 146B outputs the output value of the rate limiter 146Bc as the target-state longitudinal position Ltgt when a value obtained by performing the process of MinMax processor 146Bb on the temporary target-state longitudinal position increases. The target-state longitudinal position Ltgt is a value indicating by what distance the initial-state lateral difference Δy₀ is to be resolved after traveling along the road. By performing this process, it is possible to curb excessive delay of resolution of the initial-state lateral difference Δy₀ due to an excessive increase of the target-state longitudinal position Ltgt in a situation in which the host vehicle M is accelerating. Particularly, in a situation in which lane change is performed, a time to completion of lane change increases longitudinally when resolution of the initial-state lateral difference Δy₀ is delayed, and thus the aforementioned control can be suitably performed.

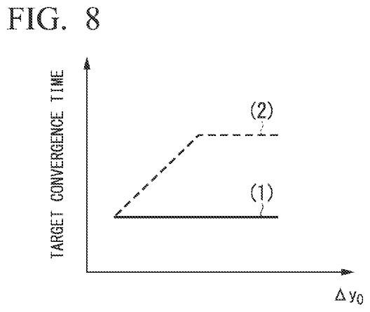

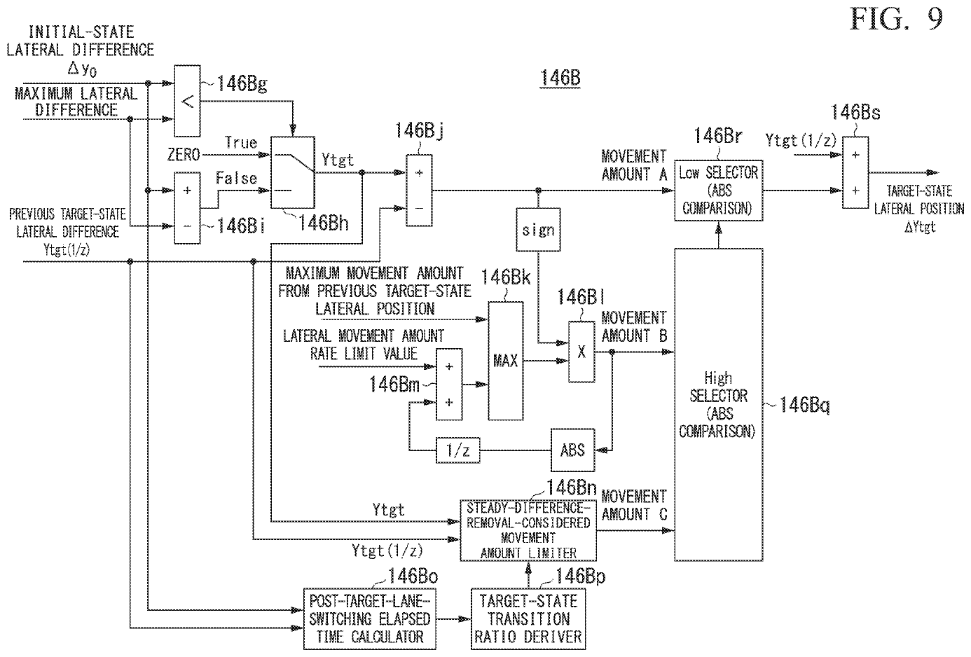

FIG. 9 is a diagram illustrating an example of a functional configuration for calculating the target-state lateral position in the target state calculator 146B. In addition to the configuration illustrated in FIG. 7, the target state calculator 146B further includes, for example, a comparator 146Bg, a selector 146Bh, subtractors 146Bi and 146Bj, a MAX processor 146Bk, a multiplier 146B1, an adder 146Bm, a post-target-lane-switching elapsed time calculator 146Bo, a target-state transition ratio calculator 146Bp, a steady-difference-removal-considered movement amount limiter 146Bn, a High selector 146Bq, a Low selector 146Br, and an adder 146Bs.

The comparator 146Bg is configured to output 1 to the selector 146Bh when the initial-state lateral difference Δy₀ is less than a maximum lateral difference and to output zero to the selector 146Bh otherwise. The selector 146Bh is configured to output a set value (for example, zero) as the target-state lateral difference Ytgt when 1 is input from the comparator 146Bg and to output a value, which is obtained by subtracting the maximum lateral difference from the initial-state lateral difference Δy₀ and is calculated by the subtractor 146Bi, as the target-state lateral difference Ytgt when zero is input from the comparator 146Bg. The subtractor 146Bj outputs a value obtained by subtracting the previous target-state lateral difference Ytgt(1/z) from the target-state lateral difference Ytgt as a movement amount A.

The sign function value sign(A) of the movement amount A is input to the multiplier 146B1. On the other hand, a maximum movement amount (a constant value) from the previous target-state lateral position and a sum of a previous value ABS(B)(1/z) of ABS(B) which is the absolute value of the previous output (movement amount B) of the multiplier and the rate limit value of the lateral movement amount are input to the MAX processor 146Bk. The MAX processor 146Bk outputs the larger of the input values to the multiplier 146B1. The multiplier 146B1 outputs a value (movement amount B) obtained by multiplying the sign function value sign(A) of the movement amount A by the value input from the MAX processor 146Bk to the High selector 146Bq.

The target-state lateral difference Ytgt and the previous target-state lateral difference Ytgt(1/z) are input to the steady-difference-removal-considered movement amount limiter 146Bn. The steady-difference-removal-considered movement amount limiter 146Bn calculates a movement amount C, for example, by solving following Equation (1).

C=w·Ytgt+(1−w)·Ytgt(1/z) (1)

The initial-state lateral difference Δy₀ and the previous target-state lateral difference Ytgt(1/z) are input to the post-target-lane-switching elapsed time calculator 146Bo. For example, when a difference between the initial-state lateral difference Δy₀ and the previous target-state lateral difference Ytgt(1/z) is greater than a set value, the post-target-lane-switching elapsed time calculator 146Bo determines that a target lane has been switched, measures (counts) an elapsed time from a time point of such determination, and outputs the counted time to the target-state transition ratio calculator 146Bp.

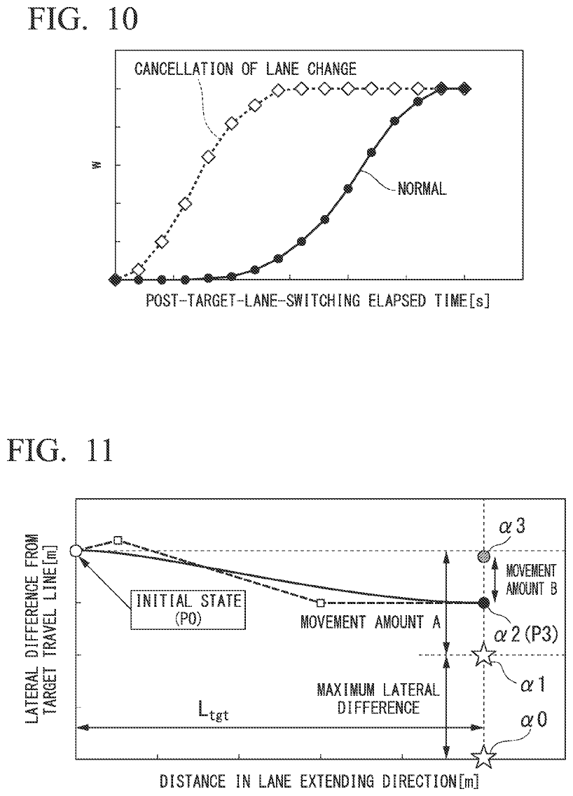

As the elapsed time becomes longer, the target-state transition ratio calculator 146Bp increases a target-state transition ratio (a coefficient w) to approach 1. The target-state transition ratio calculator 146Bp makes these increase characteristics be different between the normal state and the time of cancellation of lane change. FIG. 10 is a diagram illustrating an example of the characteristics of the target-state transition ratio. The target-state transition ratio calculator 146Bp increases the coefficient w earlier with respect to the elapsed time at the time of cancellation of lane change than in the normal state. The calculated coefficient w is provided to the steady-difference-removal-considered movement amount limiter 146Bn.

The High selector 146Bq outputs one movement amount with the larger absolute value of the movement amount B and the movement amount C to the Low selector 146Br. The Low selector 146Br outputs one with the smaller absolute value of the movement amount A and the output value of the High selector 146Bq as a movement amount from the previous target state to the adder 146Bs.

The adder 146Bs outputs a sum of the movement amount from the previous target state and the previous target state as a target-state lateral position ΔTtgt.

The movement amounts A, B, and C will be described below. FIG. 11 is a diagram illustrating a process which is performed by the target state calculator 146B. In the drawing, the vertical axis represents a lateral difference from the target travel line L # and the horizontal axis represents a distance in a travel direction of a lane with respect to the position of the representative point of the host vehicle M. In the drawing, initial state (P0) indicates the initial-state lateral difference Δy₀ and α0 indicates a lateral position of the target travel line L #. Here, α0 (the lateral position of the target travel line L #) may be corrected according to a curve as follows. The target state calculator 146B determines an extraction range of a turning radius R (which means a radius of curvature of a road) according to the speed v of the host vehicle M based on characteristics illustrated in FIG. 12. The extraction range of the turning radius R is information for defining in what range in the travel direction from the host vehicle M information is to be referred to out of information for monitoring the outside circumstances such as a captured image from the camera 10. The target state calculator 146B determines a temporary target state correction value corresponding to the turning radius R based on characteristics illustrated in FIG. 13. The target state calculator 146B determines a target-state correction value by limiting a rate of change of the temporary target-state correction value using the rate limiter. The position α0 is corrected based on the target-state correction value.

Referring back to FIG. 11, al is a target state in which limitation from the initial state is reflected. A difference between α0 and α1 corresponds to the movement amount A. α2 is a target state in which limitation from a previous target state α3 converted to a current host-vehicle coordinate system is reflected. A difference between α2 and α3 corresponds to the movement amount B. α2 is used as lateral coordinates of a control point P3 on a Bezier curve which will be described later. Although not illustrated in FIG. 11, the movement amount C is a correction value for causing α2 to reliably approach α0.

[Calculation of Reference Line]

The difference convergence reference calculator 146C calculates an adjustment value (a difference convergence reference) in the lateral direction which is added to the target travel line L #. The difference convergence reference calculator 146C calculates the difference convergence reference, for example, by applying an initial state and a target state to a geometric curve such as a Bezier curve. In the following description, it is assumed that a Bezier curve is used. The initial state which is applied to the Bezier curve includes an initial-state speed v₀, an initial-state lateral difference Δy₀, and an initial-state posture angle difference Δθ₀. The target state which is applied to the Bezier curve includes a target-state longitudinal position Ltgt and a target-state lateral position ΔYtgt. The difference convergence reference is calculated by applying an initial-state successive time T and a lateral difference convergence coefficient u as parameters thereto.

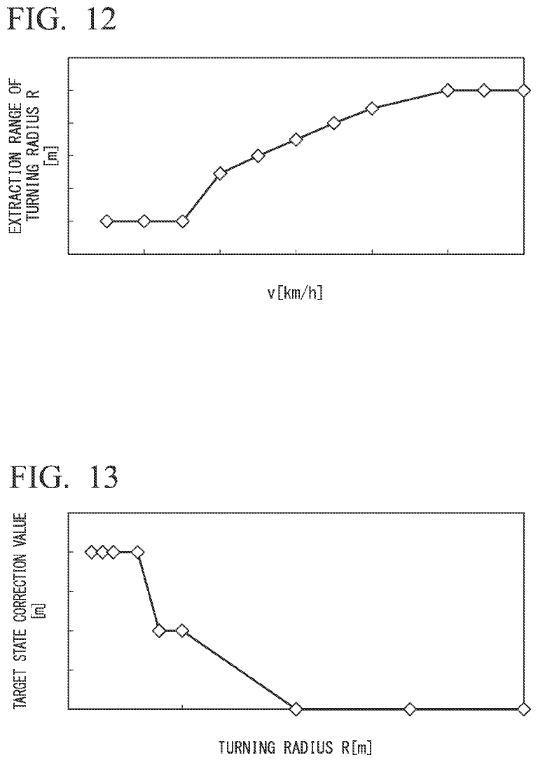

FIG. 14 is a diagram illustrating a process which is performed by the difference convergence reference calculator 146C. The difference convergence reference calculator 146C determines a curve of the difference convergence reference by defining four control points (P0 to P3). Coordinates of the control points are determined as follows.

P0: (0, Δy₀)

P1: (v₀·T·cos θ₀, v₀·T·cos θ₀)

P2: (k·Ltgt, Δytgt)

P3: (Ltgt, Δytgt)

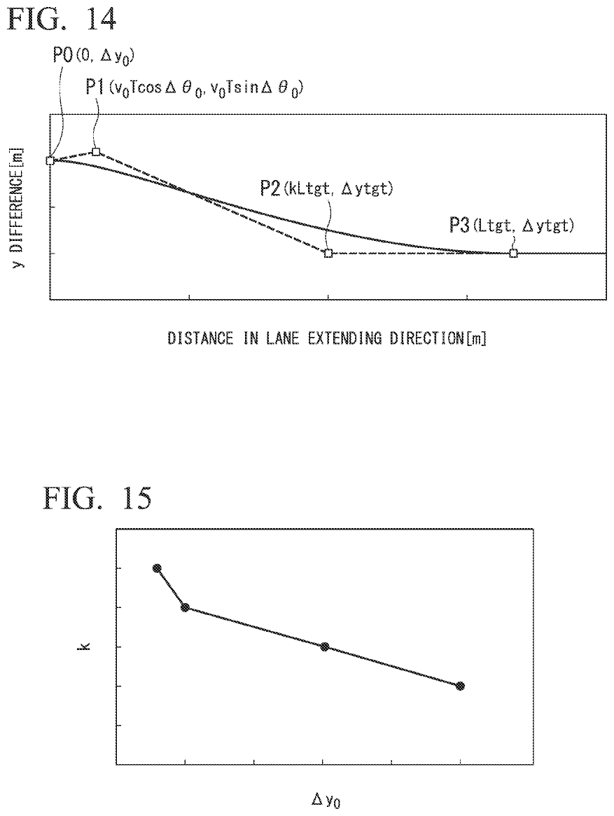

The initial-state successive time T is, for example, a fixed value and is set to a time which is shorter at the time of cancellation of lane change than in the normal state. The difference convergence reference calculator 146C sets the lateral difference convergence coefficient u, for example, according to characteristics illustrated in FIG. 15. The difference convergence reference calculator 146C sets the lateral difference convergence coefficient u to be smaller as the initial-state lateral difference Δy₀ becomes larger. When the lateral difference convergence coefficient u decreases, the control point P2 becomes close to the control point P0 and thus the lateral difference converges more rapidly. A shortest distance between the control points P0 and P1 may be set. Since the curve of the difference convergence reference is always located inside of a convex hull of the control points, it is possible to prevent divergence (overshooting) of control.

Since the difference convergence reference is prepared in a lane coordinate system, that is, a coordinate system with directions substantially parallel to the road extension direction and the road width direction as axes, the reference line calculator 146D converts the difference convergence reference to a host-vehicle coordinate system. The host-vehicle coordinate system is a coordinate system in which the representative point of the host vehicle M is set as an origin and a direction of a vehicle-body center line and a vehicle width direction perpendicular thereto are set as axes. The reference line calculator 146D calculates a reference line Lref by adding the difference convergence reference converted to the host-vehicle coordinate system to the target travel line L #.

[Extraction of Time-Series Tracking Trajectory]

The time-series tracking trajectory generator 148 generates a time-series tracking trajectory based on the successive trajectory iLref and the reference line Lref. The time-series tracking trajectory Tjt is obtained by generating a control value for each period (for example, about a hundred [ms]) from an initial state in several seconds [sec]. Accordingly, the time-series tracking trajectory Tjt is expressed by a series of points (time-series trajectory points) at which the host vehicle M is to arrive from the initial state for each period. A future arrival timing for each period for each point is referred to as a sampling timing.

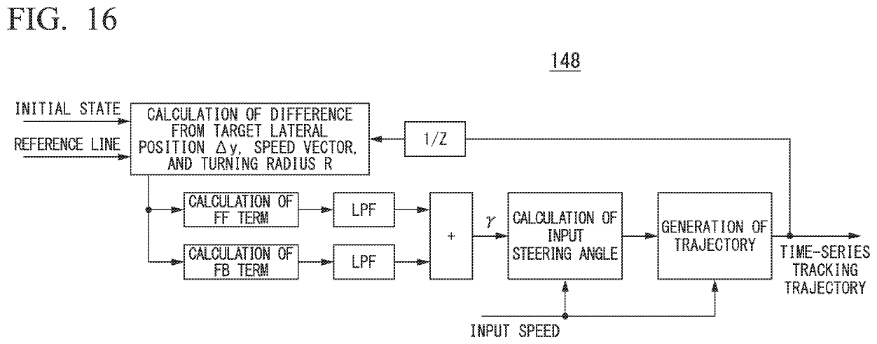

FIG. 16 is a diagram illustrating process details which are performed by the time-series tracking trajectory generator 148. The time-series tracking trajectory generator 148 calculates a difference Δy, a speed vector (Vx, Vy), and a curvature R of a road at each sampling timing based on the initial state and the reference line. The difference Δy is a distance between a position to which the host vehicle M has moved with the elapse of the sampling timings and a position on the reference line Lref corresponding to the position (a point at which a straight line extending in the lateral direction from the position to which the host vehicle has moved and the reference line Lref cross: hereinafter referred to as a “corresponding position”). The time-series tracking trajectory generator 148 calculates an FF term and an FB term at each sampling timing. The FF term and the FB term are expressed by Equations (2) and (3). Here, AO is a slope of a tangent line of the reference line Lref at the corresponding position with respect to the vehicle-body center axis of the host vehicle M.

(FF term)=(Vx·cos Δθ−Vy·sin Δθ)/(R−Δy) (2)

(FB term)={1/(Vx·cos Δθ−Vy·sin Δθ)}·{−K_{D}·(dΔy/dt)−K_{P}·Δy−K_{I}·∫Δy·dt} (3)

The time-series tracking trajectory generator 148 calculates a target yaw rate γ by performing a low-pass filter process on the FF term and the FB term and adding the results to the terms. The time-series tracking trajectory generator 148 calculates an input steering angle based on the target yaw rate γ and an input speed. The input speed is acquired, for example, from information serving as a base of the speed vector and is used to estimate a steering angle from the yaw rate or to calculate a position of a vehicle in a next time step at the time of generating a trajectory. At this time, the time-series tracking trajectory generator 148 limits the input steering angle such that a lateral acceleration does not exceed an upper limit value. Subsequently, the time-series tracking trajectory generator 148 inputs the input steering angle and the input speed to a vehicle model such as an equivalent two-wheel model or a geometric motion model and generates a time-series tracking trajectory Tjt corresponding to one sampling timing. By using such a vehicle model, it is possible to generate the time-series tracking trajectory Tjt that does not exceed a motion limit of the host vehicle M and to prevent sudden behavior from occurring in the host vehicle M. Information such as the position, the posture, the speed, and the steering angle which are generated in the step of generating a trajectory is reflected in the processes of calculating the difference Δy, the speed vector (Vx, Vy), and the turning radius R at a next sampling timing.

[Generation of Output Route]

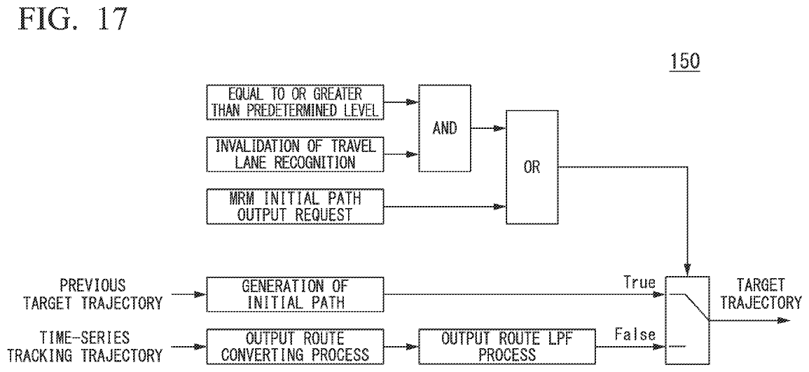

FIG. 17 is a diagram illustrating a process which is performed by the output route generator 150. The output route generator 150 selectively outputs one of an initial path and a path based on the time-series tracking trajectory Tjt as a target trajectory. The initial path is a path which is obtained by generating a path output as a target trajectory in a previous control cycle again using the position of the host vehicle M in a current control cycle as a start point in the longitudinal direction. The path based on the time-series tracking trajectory Tjt is calculated by performing an output route converting process and an output route LPF process on the time-series tracking trajectory Tjt.

For example, the output route generator 150 is configured to output the initial path as a target trajectory when the automated driving level is equal to or higher than a predetermined level and recognition of a travel lane by the recognizer 130 is invalid or when a minimum risk maneuver (MRM) initial path output request is issued and to output a path based on the time-series tracking trajectory Tjt as a target trajectory otherwise. The predetermined level is, for example, an automated driving level at which a driver's unholding is permitted. The MRM initial path output request is issued for the host vehicle M to stop automatically when an occupant who is to perform manual driving does not perform a driving operation.

In the output route converting process, the output route generator 150 converts the time-series tracking trajectory Tjt in each period to an output route (temporary target trajectory Tj #) at intervals of a constant distance (for example, every several [m]). The temporary target trajectory Tj # is acquired by generating a control value for each predetermined distance cycle (for example, about several hundreds [ms]) from the initial state in several seconds [sec]. Accordingly, the temporary target trajectory Tj # is expressed by a series of points (trajectory points) at intervals of a constant distance at which the host vehicle M is to arrive from the initial state.

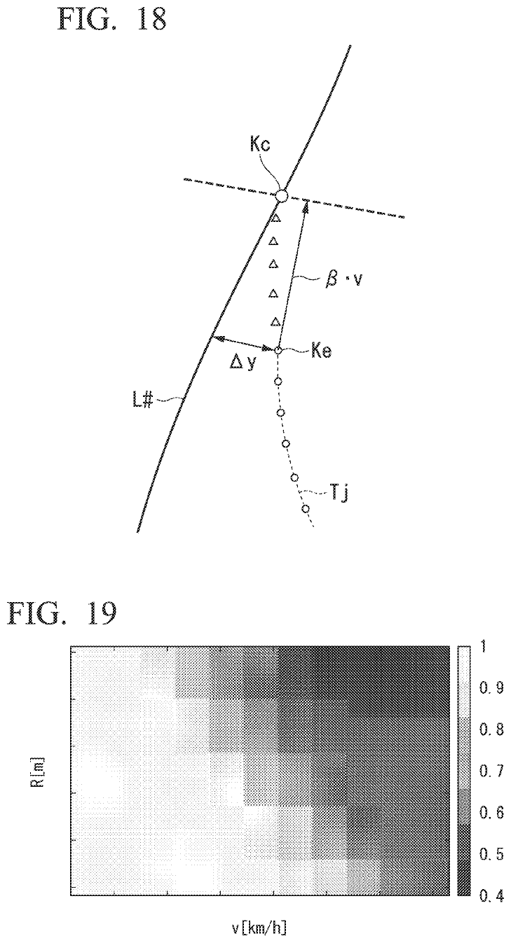

At the time of converting the time-series tracking trajectory Tjt to the temporary target trajectory Tj #, since the temporary target trajectory Tj # does not reach a lower-limit distance (for example, about a hundred [m]) when the length of the time-series tracking trajectory Tjt does not reach the lower-limit distance, the output route generator 150 may perform an extrapolation process for extending the temporary target trajectory Tj # to the low-limit distance. This is because the length of the time-series tracking trajectory Tjt depends on the speed of the host vehicle M and may be less than the lower-limit distance when the speed is low. FIG. 18 is a diagram illustrating the extrapolation process. In the drawing, Ke is a trajectory point farthest from the host vehicle M out of the trajectory points constituting the temporary target trajectory Tj #. In this case, first, the output route generator 150 determines a convergence point Kc. The output route generator 150 determines a point corresponding to a certain point in the direction of the speed v (a point at the same position in the vertical direction) as a convergence point Kc, for example, using a distance obtained by multiplying the speed v of the host vehicle M by a predetermined time (for example, a time of about several seconds [sec]) from a viewpoint of the host vehicle M. Trajectory points are extrapolated at predetermined distance intervals such that the distance Δy in the lateral direction from the target travel line L # decreases at a constant pace (the distance Δy decreases by a constant width as it becomes close to one convergence point Kc). In the drawing, the extrapolated trajectory points are indicated by white triangles.

In the output route LPF process, the output route generator 150 generates a target trajectory Tj by mixing the target trajectory Tj(k−1) generated in the previous control cycle and the temporary target trajectory Tj #(k) generated through the output route converting process in the current control cycle. The output route generator 150 generates the target trajectory, for example, based on Equation (4). In the equation, q is a coefficient. Since a trajectory point in the target trajectory Tj(k−1) generated in the previous control cycle may not match the position of the representative point of the host vehicle M, the output route generator 150 performs the mixing process (LPF process) after resetting the target trajectory Tj(k−1) generated in the previous control cycle with respect to the position of the representative point of the host vehicle M. The LPF process may be performed in consideration of the target trajectories Tj(k−2) and Tj(k−3) and the like generated in the previous control cycles two times before and three times before as well as the target trajectory Tj(k−1) generated in the previous control cycle.

Tj=(1−q)·Tj(k−1)+q·Tj#(k) (4)

The output route generator 150 determines the coefficient q, for example, based on the speed v of the host vehicle M and the turning radius R. FIG. 19 is a diagram illustrating a technique of determining the coefficient q. As illustrated in the drawing, the output route generator 150 decreases the coefficient q as the speed v increases and decreases the coefficient q as the turning radius R decreases (as the curve becomes sharper). When the coefficient q decreases, a proportion at which the target trajectory Tj(k−1) generated in the previous control cycle is reflected increases and thus sudden change of control is curbed. The output route generator 150 may not perform the LPF process and output the temporary target trajectory Tj #(k) generated in the output route converting process as the target trajectory (Tj(k) without any change when at least some of condition (a) in which a map which can be referred to for the current position of the host vehicle M is not included in the second map information 62, condition (b) in which avoidance control is performed because the host vehicle approaches a road marking, condition (c) in which lane change is being performed (including a condition in which lane change is being cancelled), condition (d) in which ELK (a generic term of automatic steering functions at emergency such as lane departure) is being performed, and condition (e) in which in-lane travel control is turned off are satisfied.

The output route generator 150 prepares additional information which will be described below along with the target trajectory Tj and outputs the resultant to the second controller 180. The output route generator 150 calculates a distance to a left boundary point and a distance to a right boundary point for each trajectory point of the target trajectory Tj and adds the calculated distances to the additional information.

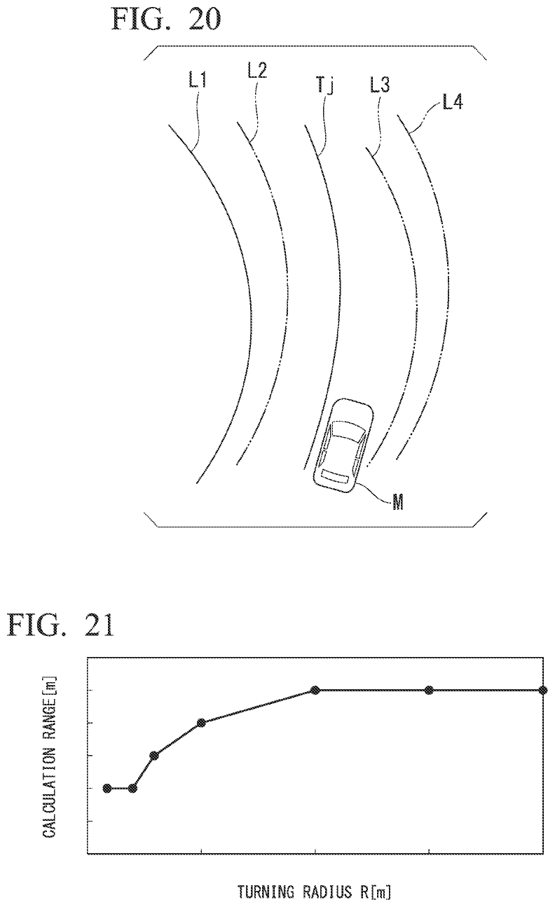

FIG. 20 is a diagram illustrating a process of generating the additional information. The left boundary point is a boundary line closer to a trajectory point of a left boundary line (L1) of a travel lane recognized using a camera and a left boundary line (L2) of a travel lane recognized using a map. The right boundary point is a boundary line closer to the trajectory point of a right boundary line (L3) of the travel lane recognized using the camera and a right boundary line (L4) of the travel lane recognized using the map. When the turning radius R is equal to or less than a reference value, a boundary line of which a distance from the target trajectory Tj does not increase monotonously is excluded. In the example illustrated in FIG. 20, the right boundary line (L3) of the travel lane recognized using the camera is excluded from a process object. A calculation range of the boundary line of the travel lane recognized using the camera may be adjusted based on the turning radius R. FIG. 21 is a diagram illustrating an example of characteristics for determining the calculation range of the boundary line of the travel lane recognized using the camera.

When the left boundary point and the right boundary point are calculated in correlation with each trajectory point as described above, the output route generator 150 calculates the “distance to the left boundary point” by subtracting a half of a vehicle width of the host vehicle M from the distance between the left boundary point and the trajectory point and calculates the “distance to the right boundary point” by subtracting a half of the vehicle width of the host vehicle M from the distance between the right boundary point and the trajectory point.

The output route generator 150 may add information about whether the initial state has been reset, an ELK output, whether an initial path has been generated, whether right and left road markings have been recognized by the camera 10, whether a map is used, whether information on a lane tracing a preceding vehicle is used, or whether right and left road markings have been recognized to the additional information. The additional information is used to determine whether the “predetermined level” is able to be continuously used.

According to the aforementioned embodiment, the vehicle control device includes a first line generator (the target travel line generator 142) configured to generate a first line (the target travel line L #) based on a shape of a road in the travel direction of the vehicle (the host vehicle M), a second line generator (the reference line generator 146) configured to generate a second line (the reference line Lref) such that the second line is closer to the first line than an initial state at a target arrival point by using the initial state including at least a lateral difference (Δy₀) from the first line and a target state including at least the target arrival point as parameters (P0, P3) of a geometric curve, a third line generator (the time-series tracking trajectory generator 148) configured to generate a third line (the time-series tracking trajectory Tjt) based on a target value (the target yaw rate γ) for causing a lateral difference between the first line and the second line to approach zero by feedback control, and a travel controller (the second controller 180) configured to cause the vehicle to travel based on the third line. Accordingly, it is possible to realize improvement in accuracy and curbing of a processing load.

While an embodiment of the invention has been described above, the invention is not limited to the embodiment and can be subjected to various modifications and substitutions without departing from the gist of the invention.

What is claimed is:

1. A vehicle control device comprising:
a storage device that stores a program; and
a hardware processor,
wherein the hardware processor is configured to, by executing the program stored in the storage device,
generate a first line based on a shape of a road in a travel direction of a vehicle,
generate a second line such that the second line is closer to the first line than in an initial state at a target arrival point by using the initial state including at least a lateral difference between the vehicle and the first line and a target state including at least the target arrival point as parameters of a geometric curve,
generate a third line based on a target value for causing a lateral difference between the first line and the second line to approach zero by feedback control, and
cause the vehicle to travel based on the third line.

2. The vehicle control device according to claim 1,
wherein the hardware processor is configured to:
repeatedly perform generating the first line, generating the second line, and generating the third line at intervals of a control cycle; and
set a lateral difference between a point corresponding to a position of the vehicle in a current control cycle on the second line generated in previous control cycle and the first line in the current control cycle as the lateral difference between the vehicle and the first line which is included in the initial state.

3. The vehicle control device according to claim 2,
wherein the initial state further includes an initial movement direction, and
wherein the hardware processor is configured to set a direction of a tangent to the point corresponding to the position of the vehicle in the current control cycle on the second line generated in the previous control cycle as the initial movement direction.

4. The vehicle control device according to claim 2,
wherein the hardware processor is configured to calculate a lateral position of the target arrival point in consideration of limitation based on a change from the initial state and limitation based on a change from the previous control cycle.

5. The vehicle control device according to claim 4, wherein the hardware processor is configured to
select the larger of a lateral movement amount obtained by limiting the change from the previous control cycle using a rate limiter and a load sum of a lateral movement amount calculated in the previous control cycle and a lateral movement amount calculated in the current control cycle,
select the smaller of the selected lateral movement amount and a lateral movement amount calculated according to the limitation based on the change from the initial state, and
calculate the lateral position of the target arrival point based on the lateral movement amount selected as the smaller.

6. A vehicle control method that is performed by a vehicle control device, the vehicle control method comprising:
generating a first line based on a shape of a road in a travel direction of a vehicle;
generating a second line such that the second line is closer to the first line than in an initial state at a target arrival point by using the initial state including at least a lateral difference between the vehicle and the first line and a target state including at least the target arrival point as parameters of a geometric curve;
generating a third line based on a target value for causing a lateral difference between the first line and the second line to approach zero by feedback control; and
causing the vehicle to travel based on the third line.

7. A non-transitory computer-readable storage medium storing a program causing a processor of a vehicle control device to perform:
generating a first line based on a shape of a road in a travel direction of a vehicle;
generating a second line such that the second line is closer to the first line than in an initial state at a target arrival point by using the initial state including at least a lateral difference between the vehicle and the first line and a target state including at least the target arrival point as parameters of a geometric curve;
generating a third line based on a target value for causing a lateral difference between the first line and the second line to approach zero by feedback control; and
causing the vehicle to travel based on the third line.
